(19) United States
(12) Patent Application Publication
(10) Pub. No.: US 2006/0199433 A1
(43) Pub. Date: Sep. 7, 2006

(54) Rotating latch connector system

(76) Inventors: David C. Riggs, Coppell, TX (US); Edward J. Arlt, Denver, CO (US); John Montague, Houston, TX (US)

Correspondence Address: OSHA LIANG L.L.P., 1221 MCKINNEY STREET, SUITE 2800, HOUSTON, TX, 77010, US

(21) Appl. No.: 11/232,447

(22) Filed: Sep. 21, 2005

Related U.S. Application Data
(60) Provisional application No. 60/612,980, filed on Sep. 24, 2004.

(51) Int. Cl. H01R 13/648

(52) U.S. Cl. 439/607

(57) ABSTRACT

An improved rotating latch connector system is disclosed wherein a connector assembly of the connector system includes on or more improvements such as connector lugs having a narrow width chamfered edges, or an asymmetric apex. Improvements to the receptacle assembly may include a modified two-stage entry cone, placement of one or more anti-rotation barriers within the receptacle assembly and modifications to the receptacle lugs similar to those described for the connector lugs.

### BACKGROUND OF INVENTION

1. Field of the Invention

The invention relates generally to a rotating latch connector system.

2. Background Art

Rotatable latch connector systems, often used in offshore applications such as the tethering of tension leg platforms to the seabed, typically comprise two main assemblies.

As shown in FIG. 1, a connector assembly, which represents the “male” or penetrating portion of the connector system is configured to mate with a receptacle assembly, which represents the “female” portion of the connector system.

As shown in FIG. 2, the connector assembly, when used in offshore applications, may include an extension section, an elastomeric flexible element, a connector load ring, and a bottom shroud. The connector load ring and bottom shroud will form a rotating ring that encompasses and is at least partially supported by an outer flange of the elastomeric flexible element. The connector assembly will also typically include load lugs and actuation lugs for guiding its entry into the receptacle assembly, and for interacting with various elements of the receptacle assembly during docking, latching, and/or undocking operations.

As shown in FIGS. 1 and 3, the receptacle assembly includes a load ring situated near the top of a tubular body, and a series of internal ramps and lugs disposed within the tubular body, and configured to interact with the lugs of the connector assembly. Typically, an entry cone is also situated on top of the receptacle assembly to facilitate the positioning of the connector assembly during connector/receptacle interaction.

FIG. 4 shows a representative layout of receptacle assembly ramps as viewed from within the tubular body of the receptacle assembly. During docking operations the connector assembly is centered over the receptacle assembly, typically via the entry cone. A ramped geometry at the bottom of the connector assembly lugs facilitates the centering of the connector assembly over the receptacle assembly through interaction with the sloped interior of the entry cone. This interaction may result in a rotation of the outer shell of the connector assembly so that the connector assembly lugs are aligned with the spaces between the receptacle assembly lugs.

Once centered, the lugs of the connector assembly will pass between the lugs of the receptacle assembly, which may be located along or just beneath the interior surface of the load ring of the receptacle assembly. A tight clearance between the connector and receptacle lugs (ten percent or less) functions to guide the connector lugs as they enter the receptacle assembly. As the connector lugs enter the interior of the receptacle assembly they are guided by ramps that divert the lugs so that the rotating ring of the connector assembly will be rotated such that the lugs of the connector assembly will assume a latched position, typically beneath the lugs of the receptacle assembly, once upward pressure is exerted upon the connector assembly.

During the unlatching operation, tension on the extension section may be lessened, or downward pressure exerted, until the connector assembly begins to descend within the receptacle assembly. The downward and then upward movement of the connector assembly within the receptacle assembly will result in a second diversion of the connector assembly lugs so that they are once again aligned to pass between the receptacle assembly lugs, and the connector assembly is thereby free to exit the receptacle assembly.

Although traditional rotating latch connector systems are quite effective in ideal conditions where alignment of the connector and receptacle assemblies is easily achieved, many applications in which such connector systems are used require operation under unpredictable and/or suboptimal conditions. For instance, in offset conditions, angular connector misalignment may reach 10-15 degrees or more in practical applications of such connector systems. Under such conditions, a number of difficulties are often encountered by operators due in large part to the traditionally close geometric interaction between the connector and receptacle assemblies.

FIGS. 5A-5C show one such difficulty that may be encountered during the docking of the connector assembly with the receptacle assembly. As shown in FIG. 5A, the traditionally small clearance between the lugs on the outer diameter of the rotating ring of the connector assembly and the lugs on the inner diameter of the load ring of the receptacle assembly are adequate when the two assemblies are properly aligned. However, as demonstrated in FIG. 5B, with only a five degree offset between the assemblies, the connector assembly lugs may bind between two adjacent lugs of the receptacle assembly. Although the elastomeric flexible element of the connector assembly may to some extent facilitate the deflection of the connector assembly lug so that it will eventually pass between the adjacent receptacle assembly lugs, substantial damage to the corrosion coatings and machined metal surfaces may occur in the process, due to the significant contact forces involved.

A similar problem may be encountered during the exit operation, as demonstrated in FIG. 5C. Angular offset of the connector assembly relative to the receptacle assembly during exit operations may result in the hanging of the connector assembly lug on the bottom of a receptacle assembly lug. Although the connector and receptacle lugs may eventually be freed from one another, considerable damage may result from this interaction.

Another problem sometimes encountered in practical applications of traditional rotating latch connector systems is connector lock-up during entry. As demonstrated in FIGS. 6A-6C, because the tapered upper points of the receptacle lugs and tapered lower points of the connector lugs are usually spaced at equal distances along the diameter of their respective assemblies, adjacent connector lugs may become wedged on either the facing or exterior slopes of the adjacent receptacle lugs, resulting in a locking up of the connector and receptacle assemblies. This problem may be encountered regardless of the entry angle of the connector.

A third problem sometimes encountered during the mating operation of traditional rotating latch connector systems is connector wedging at entry. This problem is similar to connector lock-up, and may occur at relatively large connector entry angles combined with a large radial offset of one side of the connector assembly. Connector wedging typically will only manifest when the points of the connector lugs and receptacle lugs are closely aligned during entry. As shown in FIGS. 7-8, if the higher side of an offset connector assembly strikes the entry cone during entry operations, the connector lugs may not effectively divert the connector assembly to the center of the receptacle assembly before the bottom of the shroud of the connector assembly contacts the lugs of the receptacle assembly. The bottom shroud may then wedge itself onto the point of a receptacle lug, and a connector lug on the opposite side may wedge against the face of an adjacent receptacle lug.

For at least the reasons described above, there is a need for a rotating latch connector system that is better able to avoid the occurrence of lug interference, as well as connector lock-up and wedging during entry operations.

### SUMMARY OF INVENTION

In one embodiment, the invention relates to an improved connector assembly for a rotating latch connector system. Improvements may include, but are not limited to, the sizing and chamfering of connector lugs and the provision of asymmetric apexes on the connector lugs. Decreased width and chamfering of the connector lugs, as well as the inclusion of asymmetric apexes will advantageously decrease the occurrence of binding and lockup issues during docking and undocking of the connector and receptacle assemblies.

In one embodiment, the invention relates to an improved receptacle assembly for a rotating latch connector system. In addition to possible modifications to the receptacle lugs, including narrower widths, chamfering of edges, and asymmetrical apexes, improvements may include, but are not limited to, the provision of a multi-stage cone at the top of the receptacle assembly, and the provision of anti-rotation barriers within the receptacle assembly. Such improvements will also lessen the occurrence of binding and lockup issues during docking and undocking of the connector and receptacle assemblies.

In one embodiment, the invention relates to a method for the docking and/or undocking of a connector assembly and receptacle assembly. Such operations are facilitated by various improvements to the connector and/or receptacle assembly, as described in detail herein.

In one embodiment, the invention relates to a method of manufacturing an improved rotary latch connector system, wherein sizing and placement of connector and/or receptacle lugs is predetermined such that greater than ten percent clearance is achieved between connector lugs and adjacent receptacle lugs during connector/receptacle interaction.

Other aspects and advantages of the invention will be apparent from the following description and the appended claims.

### BRIEF DESCRIPTION OF DRAWINGS

FIG. 1 depicts a prior art rotating latch connector system.

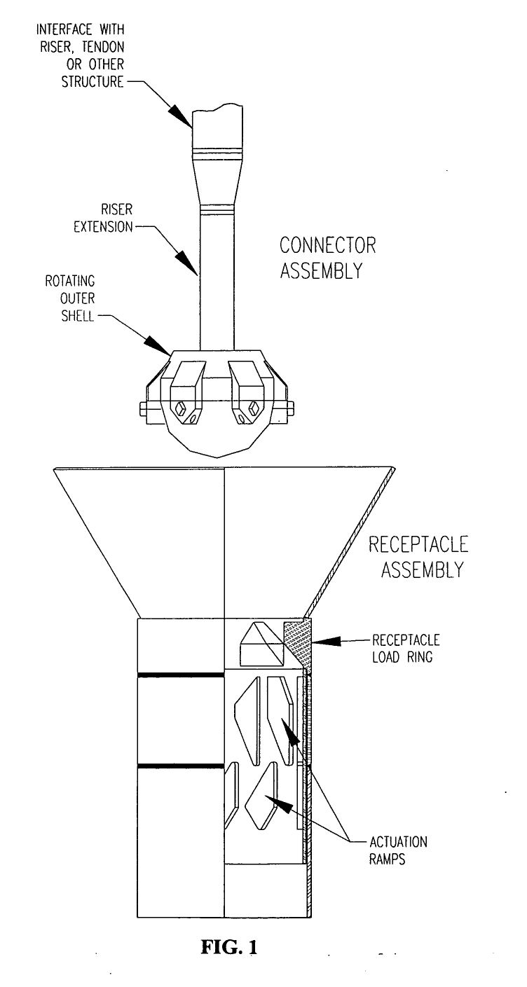

FIG. 2 depicts a connector assembly of a prior art rotating latch connector system.

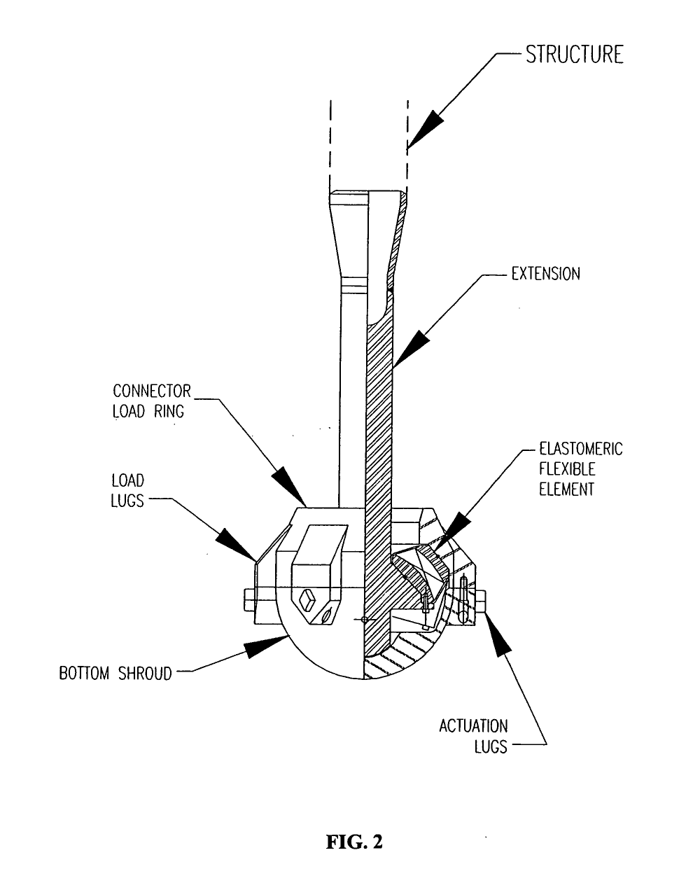

FIG. 3 depicts the interaction of a connector load ring and receptacle load ring in a prior art rotating latch connector system.

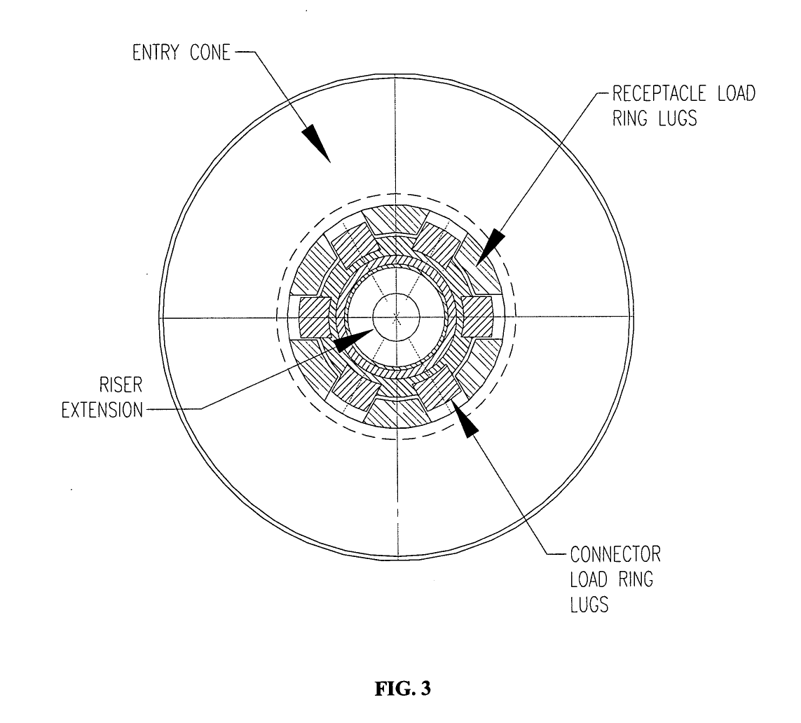

FIG. 4 depicts the interior of a the receptacle assembly of a prior art rotating latch connector system.

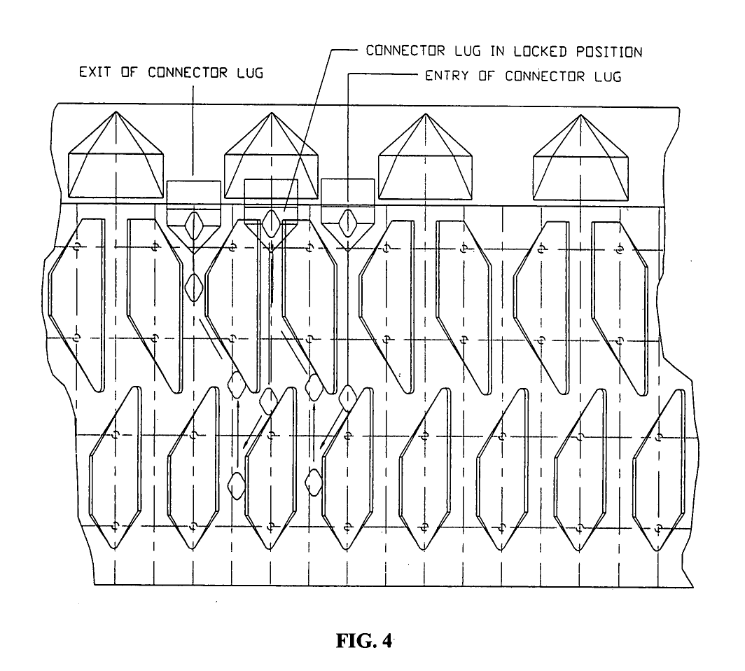

FIGS. 5A-5C depict the interaction of connector and receptacle lugs at various alignments in a prior art rotating latch connector system.

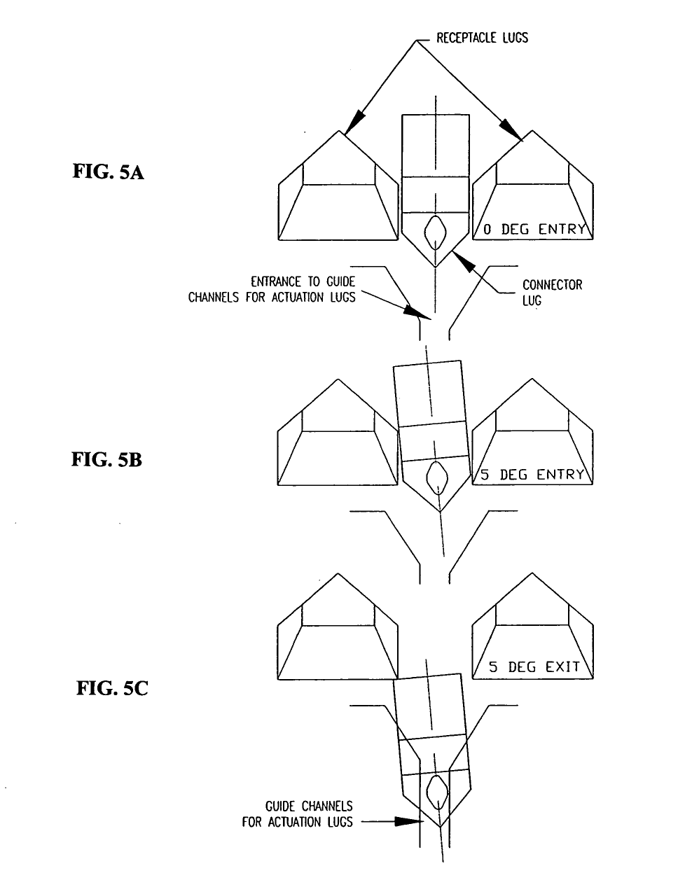

FIGS. 6A-6C depict the interaction of connector and receptacle lugs in a prior art rotating latch connector system.

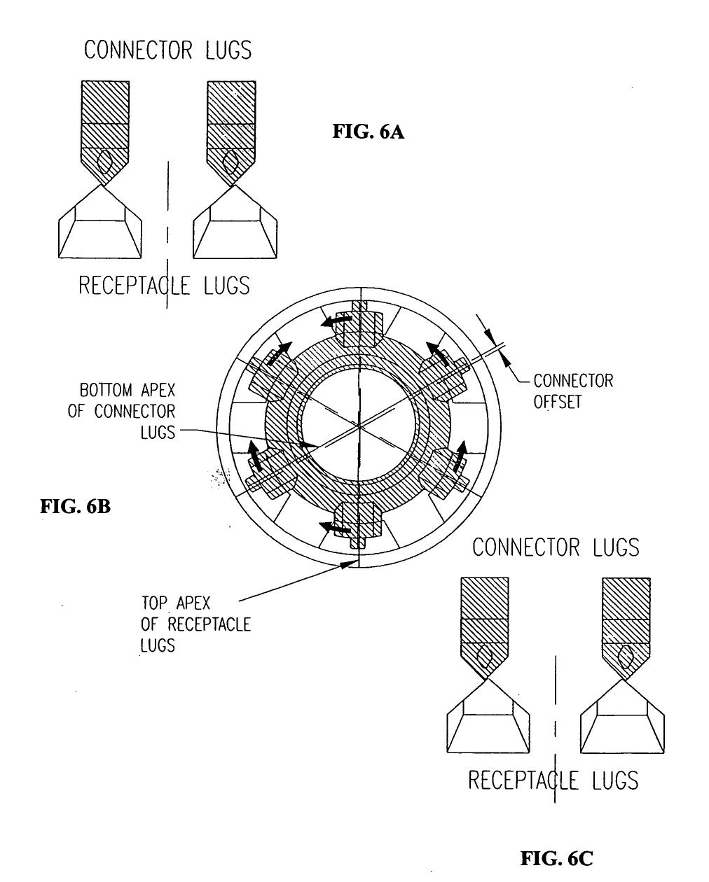

FIGS. 7A-7C depict the interaction of prior art connector and receptacle assemblies during entry operations.

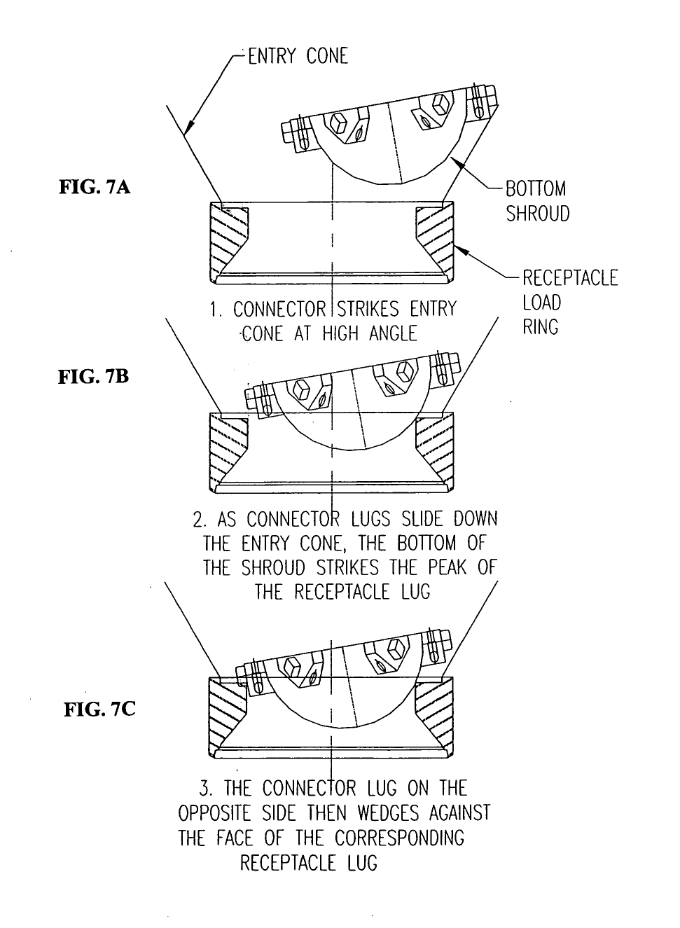

FIG. 8 is a top-down view showing the interaction of prior art connector and receptacle assemblies during entry operations.

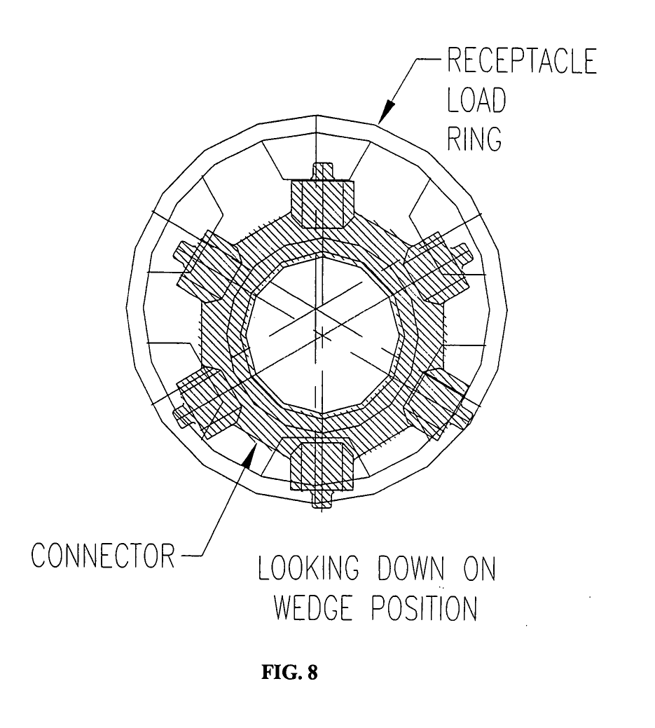

FIG. 9 depicts one embodiment of the invention.

FIGS. 10A-10C depict various interactions of a connector and two adjacent receptacle lugs according to one embodiment of the invention.

FIGS. 11A-11B depict the interaction between various components of the connector and receptacle assemblies according to one embodiment of the invention.

FIGS. 12A-12C depict non-symmetrical lug geometry according to one embodiment of the invention.

FIGS. 13A-13C depict an interaction of connector assembly with the entry cone and receptacle assembly according to one embodiment of the invention.

FIG. 14 depicts various improvements according to one embodiment of the invention.

### DETAILED DESCRIPTION

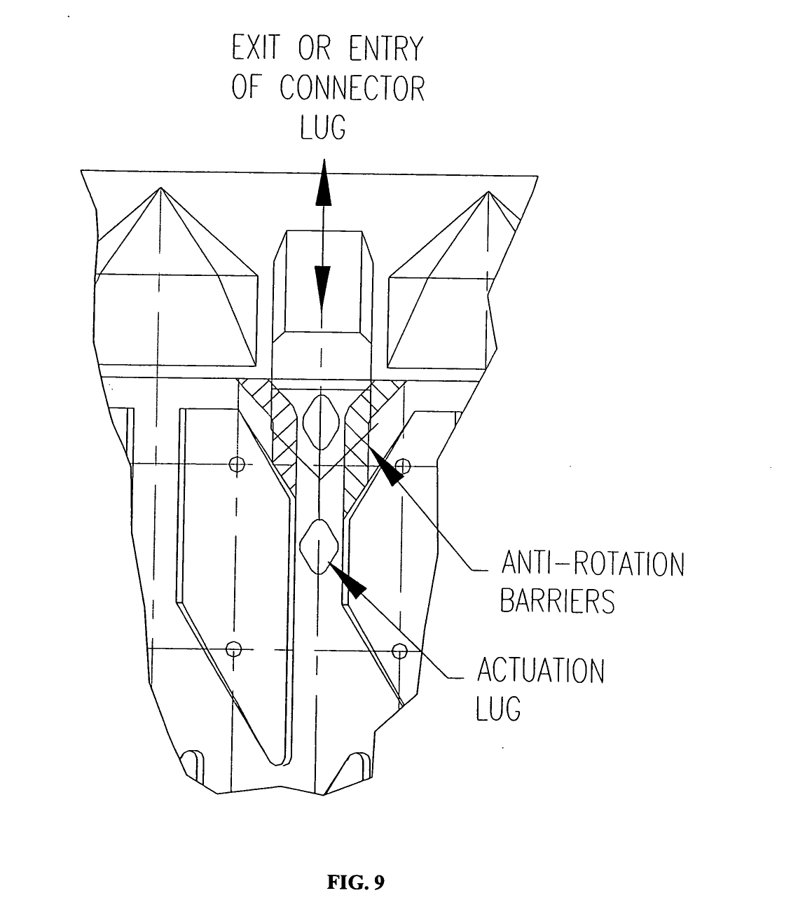

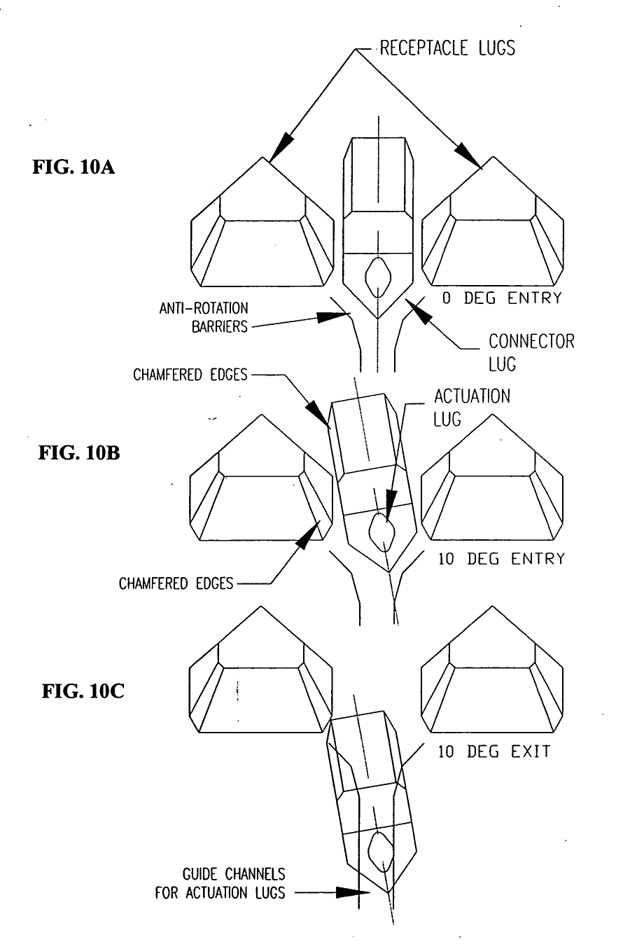

As previously described, the actuation lugs disposed on the connector lugs play a role in guiding the connector lugs through the ramps of the receptacle assembly. In one embodiment of the invention, greater control of the actuation lugs may be achieved by extending the guide channels upward toward the receptacle lugs, as shown in FIGS. 9-10, thereby facilitating proper alignment of the actuation lugs with the guide channels. Extension of the guide channels may be achieved through the use of anti-rotation barriers, or through the use of any other configuration known in the art.

The use of anti-rotation barriers advantageously permits the use of wider gaps between the connector and receptacle lugs, thereby lessening the occurrence of the various binding and lock-up problems described above. In contrast to a traditional rotating latch connector system, where the relatively tight clearance of the connector lugs (ten percent or less of the width between two adjacent receptacle lugs) assisted in the guidance and alignment of the connector lugs, wider clearances, balanced by anti-rotation barriers, will decrease undesirable contact of the connector and receptacle lugs, particularly in offset situations, resulting in a less occurences of binding and lock-up. Wider gaps between the connector and receptacle lugs may be achieved through the use of narrower lugs, or by disposing a lesser number of lugs along the diameter of the connector and/or receptacle assembly. Clearances will be in excess of ten percent, and minimum clearances of fifteen, twenty, or twenty five percent may be desirable.

Chamfering of one or more of the edges of the connector lugs and/or receptacle lugs will also lessen the occurrence of binding and lock-up problems. Alternatively, these edges may be rounded or otherwise smoothed.

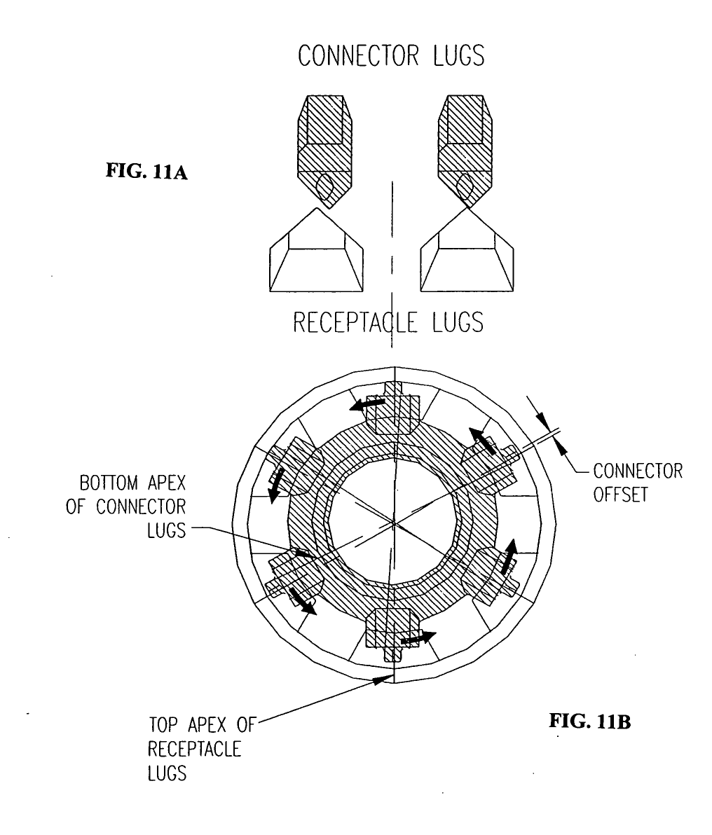

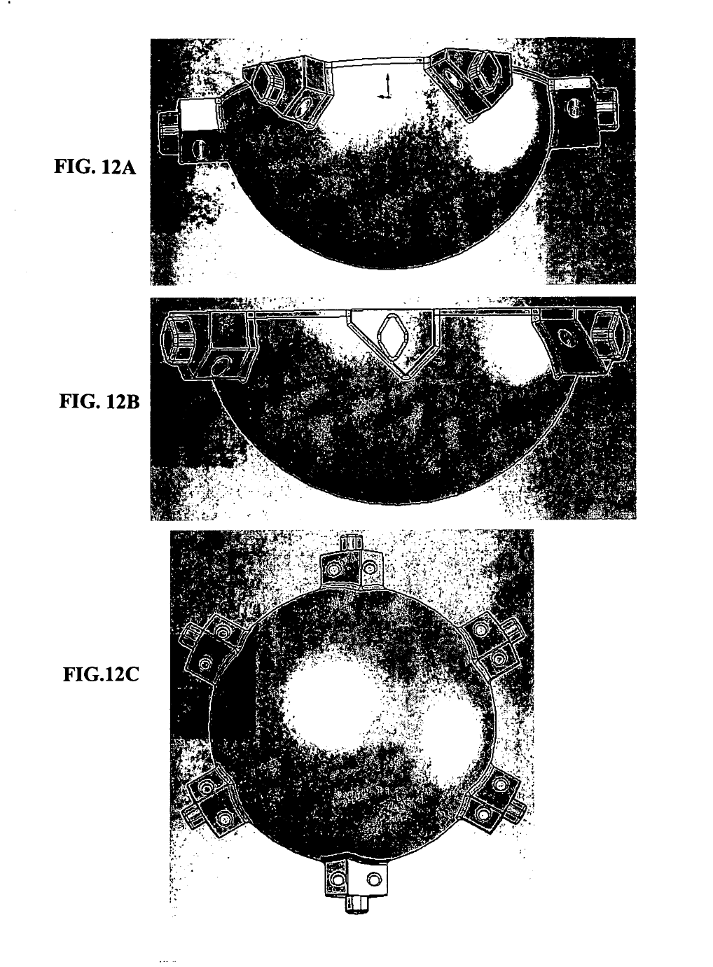

As shown in FIGS. 11-12, modifications to the symmetry or offset of the connector lugs is another solution to connector lock-up at entry. Offsetting of the apex at the bottom of the connector lugs will prevent the overlap sometimes encountered between the apexes of the connector and receptacle lugs, as described above. As used herein, apex refers to the portion of a connector or receptacle lug that tapers to a point. Typically, this will be the bottom portion of the connector lug, and the top portion of the receptacle lug. Lengthening of one or more lugs with respect to one or more other lugs may also have a similar result. These modifications may be applied to the receptacle lugs instead of, or in addition to the connector lugs, with similar results.

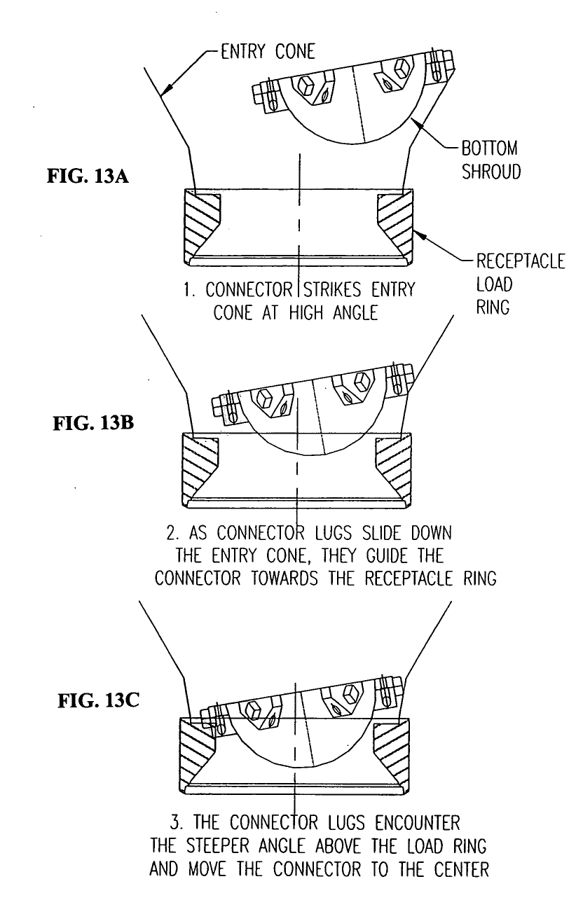

The problem of connector wedging during entry operations may also be addressed through the use of a modified entry cone, as shown in FIG. 13. The inclusion of a vertical or steeply inclined section at the bottom of the entry cone will advantageously facilitate centering of the connector assembly over the receptacle assembly, prior to contact of the connector assembly bottom shroud with the receptacle load ring, or a receptacle lug. Angle of inclination of the entry cone sides, as used herein, is relative to a line perpendicular to the longitudinal axis of the tubular body of the receptacle assembly (e.g., a vertical slope would be ninety degrees relative to this line, and would be parallel to the longitudinal axis of the tubular body).

The bottom shroud may be of any shape and/or configuration known in the art, including, but not limited to, spherical, elliptical, conical, and polygonal. Use of a conical bottom shroud may advantageously facilitate centering of the connector assembly. Use of a non-symmetrical geometry may advantageously play a role in alignment of the various components of the connector and receptacle assemblies. The shape and/or configuration of the receptacle assembly may be similarly modified to correspond with that of the connector assembly.

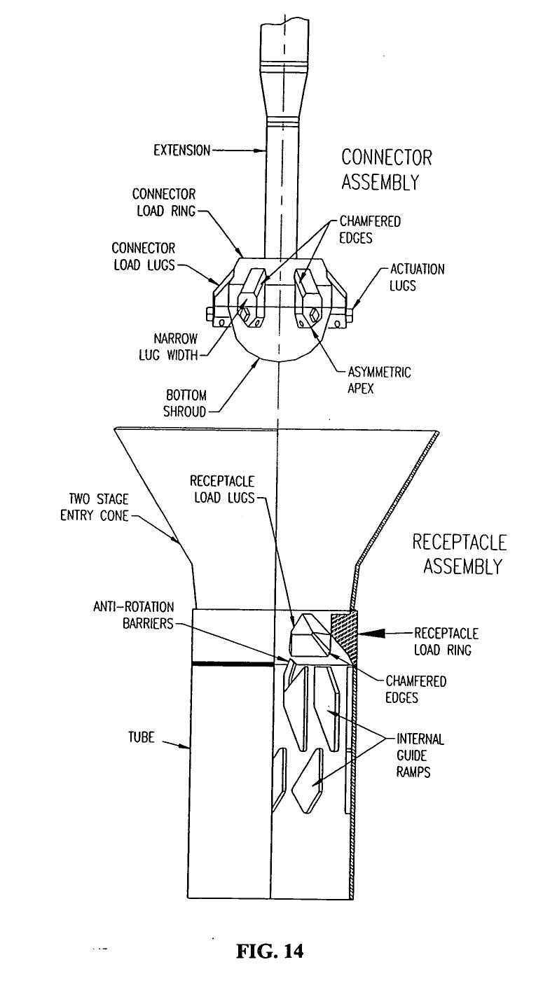

The improvements described herein may be used individually, or may be combined for potentially greater effectiveness. FIG. 14 is one embodiment of an improved rotating latch connector system. Such an improved connector system may include lugs having a narrow width, chamfered edges, and an asymmetric apex. The receptacle assembly may include a two-stage entry cone, anti-rotation barriers, and chamfered edges on the lugs. Such a combination of improvements will advantageously lessen the occurrence of binding and lock-up as described in the background section, above. As previously discussed, asymmetrical axes and a narrower lug size may be utilized with the lugs of the connector assembly and/or receptacle assembly.

Although the rotating latch connector system has been described herein in the context of sub-sea and other marine and/or petroleum production applications, the invention may also be used in other fields which might benefit from the advantages described herein. Applications may include, but are not limited to, tension legs and other tethers used in the anchoring of structures, conduit connections, riser piping, umbilical systems, and cabling operations, both terrestrial and marine. In effect, the present invention may be used with any load-bearing connection.

Furthermore, while the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A connector assembly, comprising:
a rotatable outer shell having at least one connector lug disposed at at least one predetermined point along a periphery thereof, wherein the at least one connector lug has a width that is predetermined to provide greater than ten percent clearance between the at least one connector lug and two adjacent receptacle lugs when the at least one connector lug is at least partly disposed between the two adjacent receptacle lugs.

2. The connector assembly of claim 1, wherein the clearance is at least fifteen percent.

3. The connector assembly of claim 1, wherein the clearance is at least twenty percent.

4. A connector assembly, comprising:
a rotatable outer shell having at least one connector lug disposed at at least one predetermined point along a periphery thereof, wherein at least one edge of the at least one connector lug is chamfered.

5. A connector assembly, comprising:
a rotatable outer shell having at least one connector lug disposed at at least one predetermined point along a periphery thereof, wherein an apex of the at least one connector lug is asymmetrical.

6. A receptacle assembly, comprising:
a tubular member having a load ring disposed at an upper portion thereof wherein at least one receptacle lug is disposed at at least one predetermined point along an inner diameter of the load ring, the at least one receptacle lug comprising at least one chamfered edge.

7. A receptacle assembly, comprising:
a tubular member having a load ring disposed at an upper portion thereof wherein at least one receptacle lug is disposed at at least one predetermined point along an inner diameter of the load ring, wherein an apex of the at least one receptacle lug is asymmetrical.

8. A receptacle assembly, comprising;
a tubular member having a load ring disposed at an upper portion thereof wherein at least one receptacle lug is disposed at at least one predetermined point along an inner diameter of the load ring; and
an entry cone comprising a sloping side, wherein the angle of slope is not uniform along the longitudinal length of the entry cone.

9. The receptacle assembly of claim 8, wherein the angle of slope is higher proximal the lower portion of the entry cone than the angle of slope proximal the upper portion of the entry cone.

10. A receptacle assembly, comprising;
a tubular member having a load ring disposed at an upper portion thereof wherein at least one receptacle lug is disposed at at least one predetermined point along an inner diameter of the load ring, and
at least one anti-rotation barrier disposed within the tubular member.

11. A receptacle assembly, comprising:
a tubular member having a load ring disposed at an upper portion thereof wherein a plurality of receptacle lugs are sized and disposed at predetermined points along an inner diameter of the load ring such that greater than ten percent clearance between the receptacle lugs and at least one connector lug of a connector assembly is achieved when the connector assembly is at least partly disposed within the receptacle assembly.

12. A rotating latch connector system, comprising:
a connector comprising a rotatable outer shell having at least one connector lug disposed at at least one predetermined point along a periphery thereof, and
a tubular member having a load ring disposed at an upper portion thereof wherein at least one receptacle lug is disposed at at least one predetermined point along an inner diameter of the load ring;
wherein the at least one connector lug has a width that is predetermined to provide at least ten percent clearance between the at least one connector lug and two receptacle lugs when the at least one connector lug is at least partly disposed between the two receptacle lugs.

13. The rotating latch connector system of claim 12, wherein at least one selected from the at least one connector lug and the at least one receptacle lug comprises at least one chamfered edge.

14. A method of engaging a rotating latch connector, comprising:
positioning a connector assembly proximal to a receptacle assembly;
maneuvering the connector assembly so that at least one connector lug of the connector assembly passes between two adjacent receptacle lugs of the receptacle assembly, wherein the two adjacent receptacle lugs and the at least one connector lug are configured such that a clearance of at least ten percent of the distance between the two adjacent receptacle lugs exists as the at least one connector lug passes between the two adjacent receptacle lugs;
lowering the connector assembly a predetermined distance into a tubular body of the receptacle assembly; and
raising the connector assembly until the at least one connector lug engages at least one of the two adjacent receptacle lugs such that further upward movement of the connector assembly is hindered.

15. A method of disengaging a rotating latch connector, comprising:
lowering a connector assembly disposed within a receptacle assembly a predetermined distance;
raising the connector assembly such that at least one connector lug of the connector assembly passes between two adjacent receptacle lugs, thereby freeing the connector assembly from engagement with the receptacle assembly.

16. A method of manufacturing a rotating latch connector system, comprising:
providing an outer shell;
providing a tubular body;
determining a spacing and configuration of connector lugs and receptacle lugs such that at least a ten percent clearance will be achieved when the connector lugs and receptacle lugs are placed at predetermined positions about the outer and inner diameters of the outer shell, and tubular body, respectively;
disposing at least one connector lug on the outer shell;
disposing a plurality of receptacle lugs at predetermined points on an inner diameter of the tubular body; and
disposing a plurality of ramps at predetermined locations within the tubular body.

17. The method of claim 16, further comprising chamfering at least one edge on at least one selected from a connector lug and a receptacle lug.

18. A rotating latch connector system wherein at least one selected from a connector assembly and a receptacle assembly has a non-spherical cross section across its longitudinal axis.
